(19) United States
(12) Patent Application Publication
(10) Pub. No.: US 2026/0050302 A1
(43) Pub. Date: Feb. 19, 2026

(54) ELECTRONIC DEVICE ASSEMBLY

(71) Applicant: ASRock Industrial Computer Corporation, Taipei City (TW)

(72) Inventors: Yi-Shu Hsieh, Taipei City (TW); Wen-Hao Lin, Taipei City (TW)

(73) Assignee: ASRock Industrial Computer Corporation, Taipei City (TW)

(21) Appl. No.: 19/200,687

(22) Filed: May 7, 2025

(30) Foreign Application Priority Data
Aug. 16, 2024 (TW) 113130898

(51) Int. Cl. G06F 1/18

(52) U.S. Cl. CPC G06F 1/185; G06F 1/181; G06F 1/186

(57) ABSTRACT

An electronic device assembly including a host, a second housing, a first adapter circuit board and a first function expansion module is provided. The host includes a first housing and a motherboard disposed in the first housing. The second housing assembled on one side of the first housing has a base. The first adapter circuit board is disposed on the base and is electrically connected to the motherboard. The first function expansion module is disposed on the host, wherein the first function expansion module is electrically connected to the first adapter circuit board. The first function expansion module includes a first frame and a function expansion board. The first frame has a pair of first sub-brackets facing each other. The first sub-brackets have slide rails facing each other, and the function expansion board has a sliding board suitable for moving along the slide rails.

### CROSS-REFERENCE TO RELATED APPLICATION

This application claims the priority benefit of Taiwan application serial no. 113130898, filed on Aug. 16, 2024. The entirety of the above-mentioned patent application is hereby incorporated by reference herein and made a part of this specification.

### BACKGROUND

### Technical Field

The present disclosure relates to a device assembly, and particularly relates to an electronic device assembly.

### Description of Related Art

Existing industrial computers have various types of input/output interfaces for external devices, and the quantity of interfaces required by different industries varies. In the existing technology, the input/output interfaces on the motherboard and the quantity of interfaces are typically designated for a single industrial application.

However, limited by the spatial configuration of the motherboard, the demand for input/output interfaces can only be met by increasing the size of the motherboard, resulting in increasingly larger motherboard dimensions, which is not favorable for practical application.

### SUMMARY

The present disclosure provides an electronic device assembly that facilitates functionality expansion.

The present disclosure provides an electronic device assembly including a host, a second housing, a first adapter circuit board, and a first function expansion module. The host includes a first housing and a motherboard disposed in the first housing. The second housing is assembled on one side of the first housing, and the second housing has a base. The first adapter circuit board is disposed on the base, and a normal direction of the first adapter circuit board is perpendicular to a normal direction of the motherboard, and the first adapter circuit board is electrically connected to the motherboard. The first function expansion module is disposed on the host, wherein the first function expansion module is electrically connected to the first adapter circuit board, the first function expansion module includes a first frame and a function expansion board, the first frame has a pair of first sub-brackets facing each other, the first sub-brackets have slide rails facing each other, and the function expansion board has a sliding board suitable for moving along the slide rails.

In one embodiment of the present disclosure, the motherboard is provided with a first connector, and the first adapter circuit board is provided with a second connector, wherein the first connector and the second connector mate.

In one embodiment of the present disclosure, the first adapter circuit board is provided with a third connector, the first function expansion module has a fourth connector, and the third connector and the fourth connector mate.

In one embodiment of the present disclosure, the third connector is a slot, and the fourth connector is gold fingers.

In one embodiment of the present disclosure, the first function expansion module further includes a function expansion circuit board. The function expansion circuit board is disposed parallelly on the sliding board, wherein the function expansion circuit board has a fourth connector. The first frame has a second sub-bracket connected between the first sub-brackets, and the second sub-bracket has an opening. The function expansion board also has a panel, which is disposed perpendicular to the sliding board and is suitable for covering the opening.

In one embodiment of the present disclosure, the first frame is U-shaped.

In one embodiment of the present disclosure, the electronic device assembly further includes a second function expansion module, the first function expansion module is located between the second function expansion module and the host, wherein the second function expansion module is electrically connected to the host.

In one embodiment of the present disclosure, the second function expansion module includes a second frame, and the second frame is rectangle-shaped.

In one embodiment of the present disclosure, the second function expansion module has a function expansion component that the same as a function expansion component of the first function expansion module.

In one embodiment of the present disclosure, the electronic device assembly further includes a top cover.

Based on the above, in the electronic device assembly of the present disclosure, the function expansion module is stacked in the height direction of the host to achieve the purpose of function expansion.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1A to FIG. 1D are schematics of an assembly process of an electronic device assembly according to one embodiment of the present disclosure.

FIG. 2 is an exploded view of the first function expansion module.

FIG. 3A to FIG. 3D are schematics of showing the second function expansion module being assembled onto the first function expansion module.

FIG. 4 is a schematic of showing the first function expansion module identical to the second function expansion module.

### DESCRIPTION OF THE EMBODIMENTS

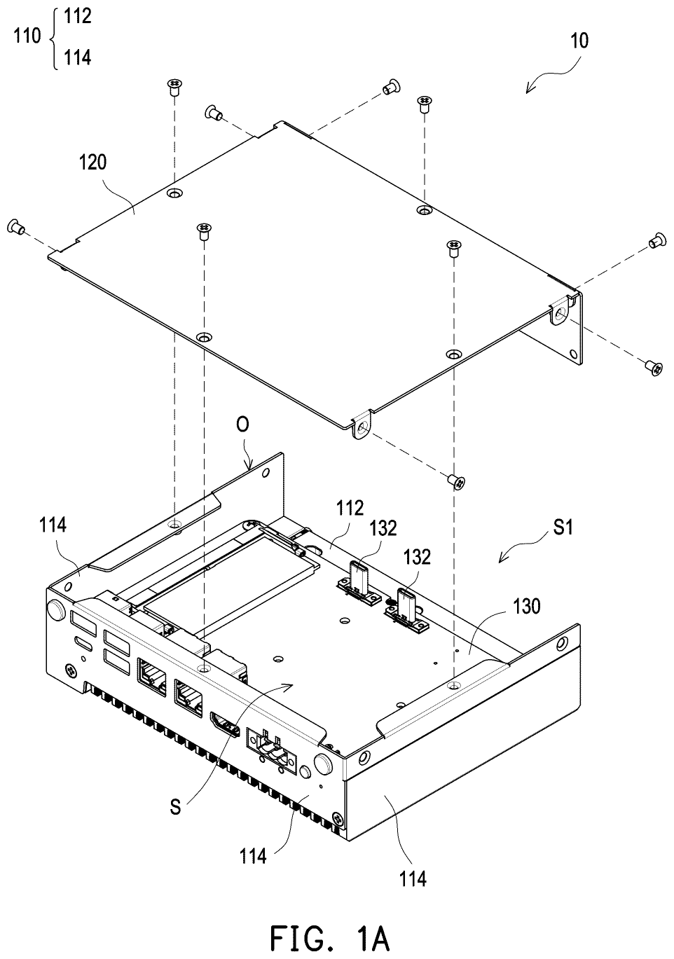

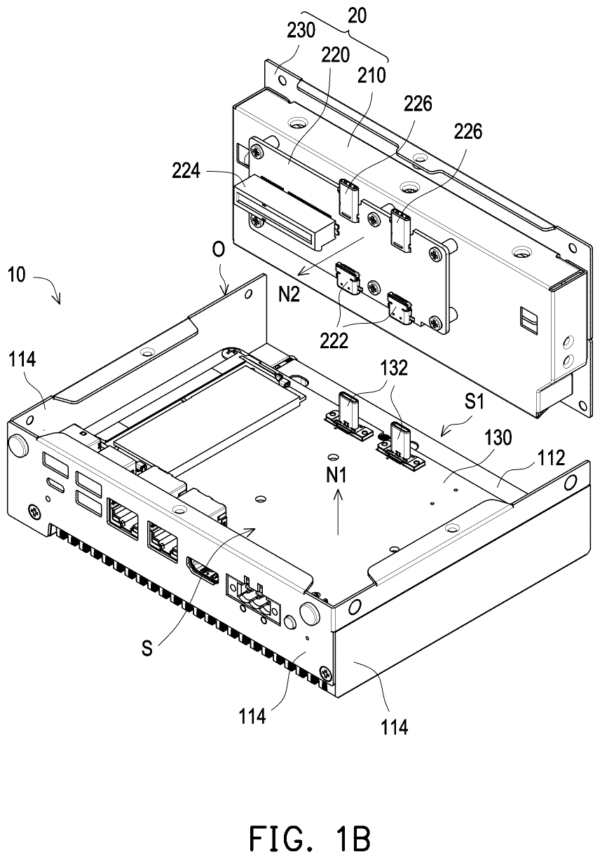

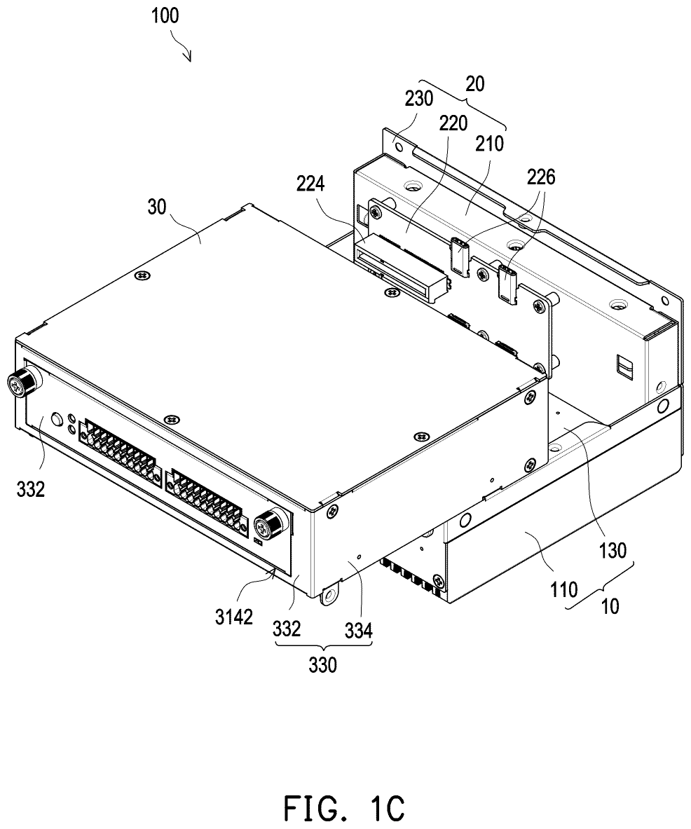

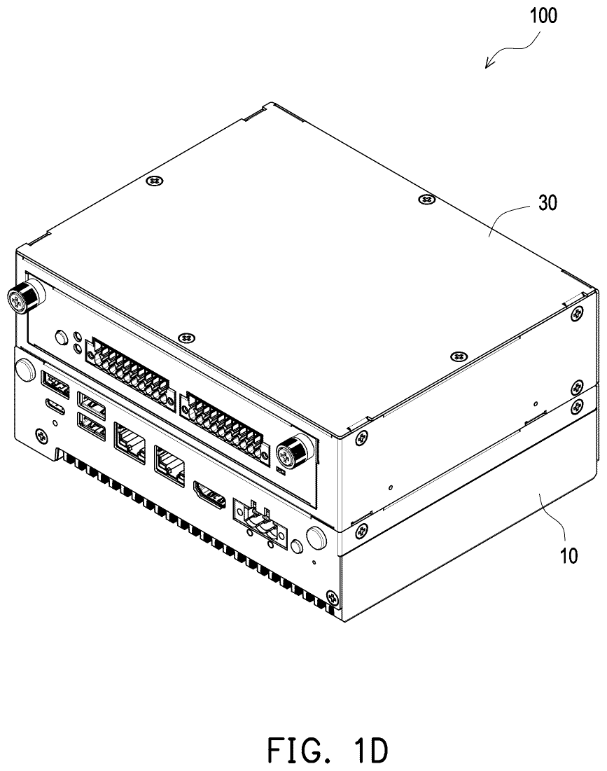

FIG. 1A to FIG. 1D are schematics of an assembly process of an electronic device assembly according to one embodiment of the present disclosure.

As shown in FIG. 1A, a host 10 is provided, the host 10 may be an industrial computer but is not limited thereto.

The host 10 includes a first housing 110, an upper cover 120, and a motherboard 130 disposed in the first housing 110. In this embodiment, the first housing 110 has a bottom cover 112 and three side walls 114 connected along three edges of the bottom cover 112. The upper cover 120 is L-shaped, and when the upper cover 120 is assembled with the first housing 110, the upper cover 120 covers one side S1 of the first housing 110 where no side wall 114 is provided and an opening O formed by the first housing 110. The motherboard 130 is contained in the space S constructed by the upper cover 120 and the first housing 110. In order to expand the functionality of the industrial computer, the upper cover 120 is removed, and therefore, the opening O of the first housing 110 exposes the motherboard 130.

As shown in FIG. 1B, a second housing 20 is provided and assembled on the side S1 of the first housing 110 where no side wall 114 is disposed. The second housing 20 of this embodiment includes a base 210, a first adapter circuit board 220, and a side cover 230. The base 210 is disposed on the second housing 20, and the first adapter circuit board 220 is disposed on the base 210 between the second housing 20 and the first adapter circuit board 220.

As mentioned above, when the second housing 20 is assembled to the first housing 110, the side cover 230 of the second housing 20 is fixed to the side S1 of the first housing 110 where no side wall 114 is provided, so that the second housing 20 and the first housing 110 together surround the space S accommodating the motherboard 130. A normal direction N2 of the first adapter circuit board 220 is perpendicular to a normal direction N1 of the motherboard 130. In addition, the second connector 222 disposed on the first adapter circuit board 220 is correspondingly connected to the first connector 132 disposed on the motherboard 130.

Next, as shown in FIG. 1C, the first function expansion module 30 is placed on the host 10, and the first function expansion module 30 is assembled with the second housing 20.

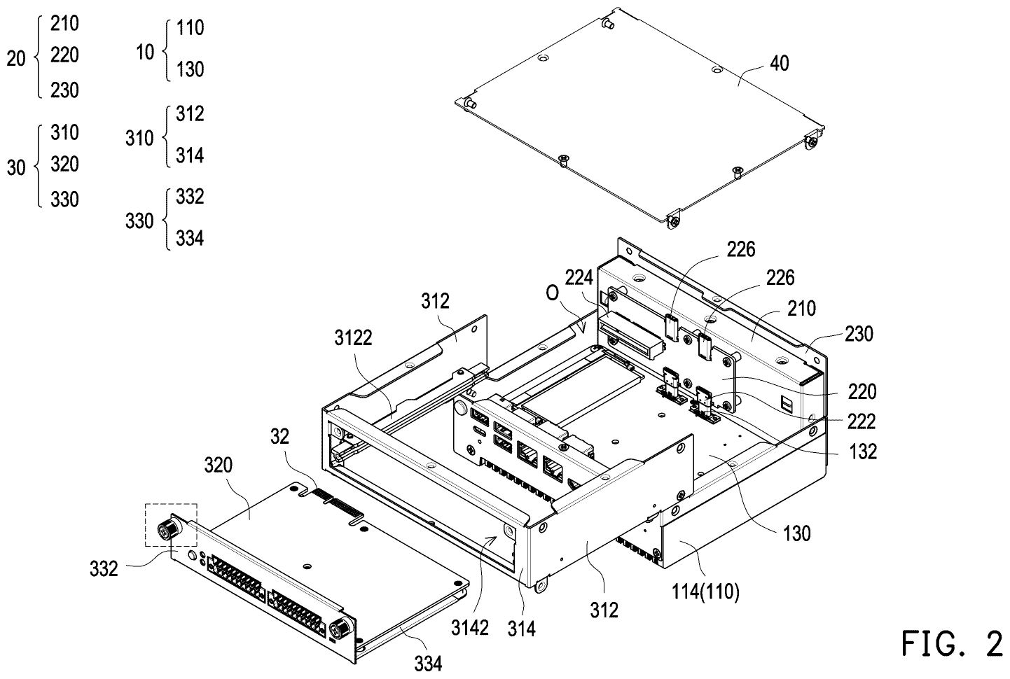

FIG. 2 is an exploded view of the first function expansion module. As shown in FIG. 2, the first function expansion module 30 of this embodiment includes a first frame 310, a function expansion panel 330, and a function expansion circuit board 320. The first frame 310 is about U-shaped, having a pair of first sub-brackets 312 facing each other and a second sub-bracket 314 connected between the two first sub-brackets 312. The first sub-bracket 312 has slide rail s 3122, the positions of the slide rails 3122 of the pair of first sub-brackets 312 correspond to each other, and the second sub-bracket 314 has an opening 3142. The function expansion panel 330 has a panel 332 and a sliding board 334 perpendicularly disposed to each other, the panel 332 is equipped with multiple I/O ports of the same or different types, the sliding board 334 is suitable to move along the slide rail 3122 to allow the function expansion panel 330 to assemble to the first frame 310, and when the function expansion panel 330 is assembled to the first frame 310, the panel 332 will cover the opening 3142 of the second sub-bracket 314. The function expansion circuit board 320 is disposed parallelly on the sliding board 334 and assembled to the first frame 310 along with the function expansion panel 330.

In the embodiment of this disclosure, the function expansion circuit board 320 has a fourth connector 32. Specifically, the assembly of the first function expansion module 30 and the second housing 20 includes the fourth connector 32 of the first function expansion module 30 inserting into the third connector 224 of the first adapter circuit board 220. Preferably, the third connector 224 is a slot, and the fourth connector 32 is gold fingers.

As the fourth connector 32 is correspondingly connected to the third connector 224, the first function expansion module 30 can achieve electrical connection with the motherboard 130 for signal transmission through the first adapter circuit board 220 of the second housing 20. Thus, as shown in FIG. 1D, the host 10 achieves the functionality expansion, completing the electronic device assembly 100. At this time, the first function expansion module 30 covers the opening O of the first housing 110.

In addition, the electronic device assembly 100 also includes a top cover 40, this top cover 40 has a different structure from the upper cover 120 of the host 10, the top cover 40 is a plate, assembled with the first frame 310 and the side wall 230 of the second housing 20 from the top of the first frame 310, to cover the interior of the first function expansion module 30.

The above-mentioned assembly refers to the interlocking relationship between components that may be achieved through screw fastening, corresponding engagement of concave-convex structures, or the mating between hooks and grooves or openings.

From the above, it is known that in this embodiment, the function expansion module 30 is stacked on top of the host 10 in a thickness direction of the host 10, therefore it is not necessary to change the dimension of the original design of the motherboard 130.

Although the aforementioned embodiment is explained with one function expansion module 30 as an example, it is not limited thereto. Multiple function expansion modules 30 may be stacked on the host 10 according to practical requirements.

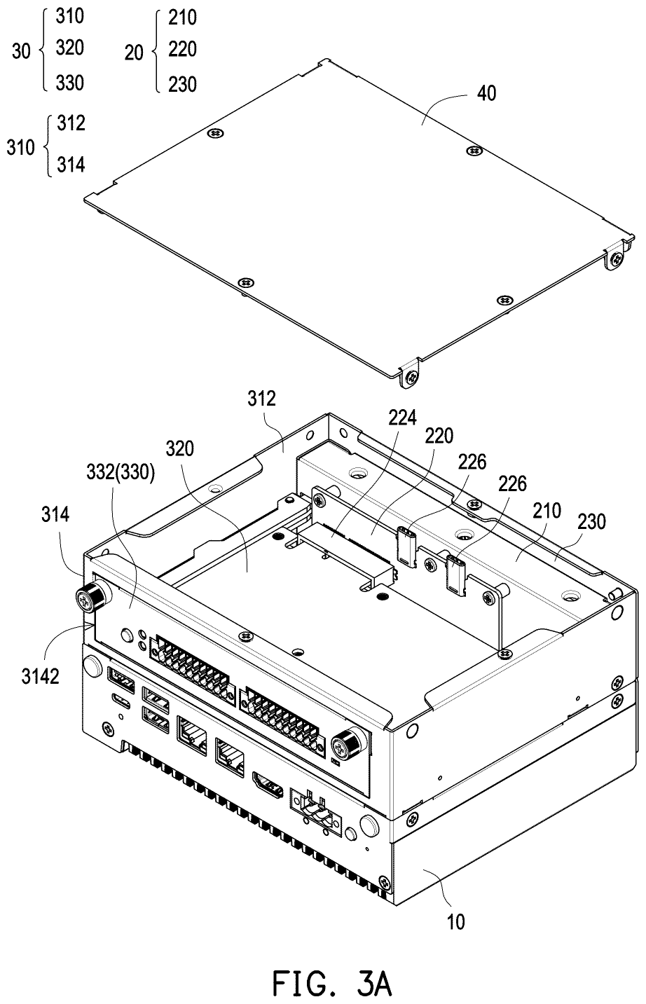

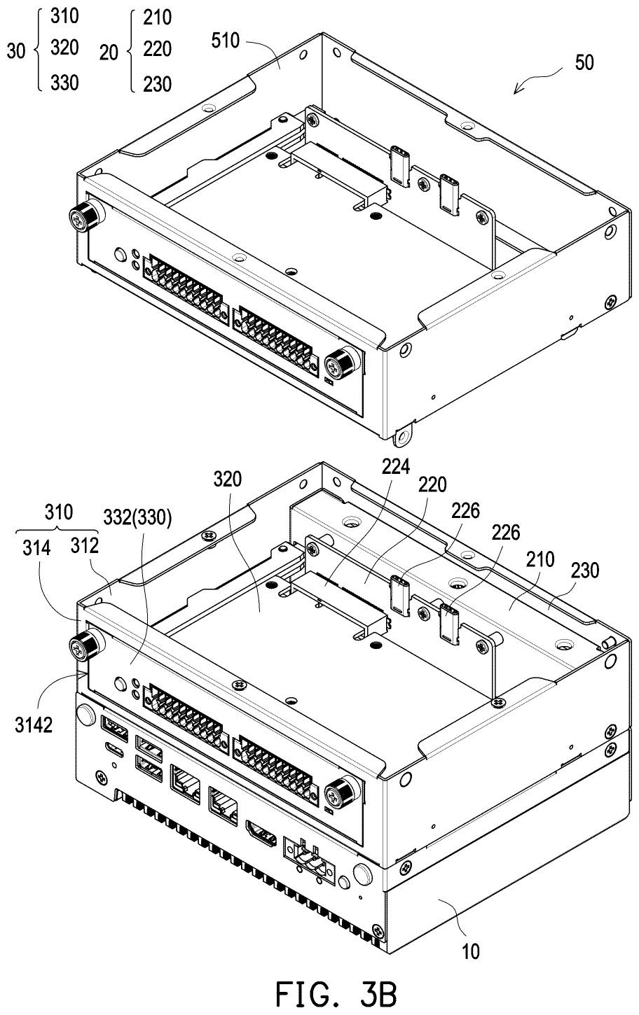

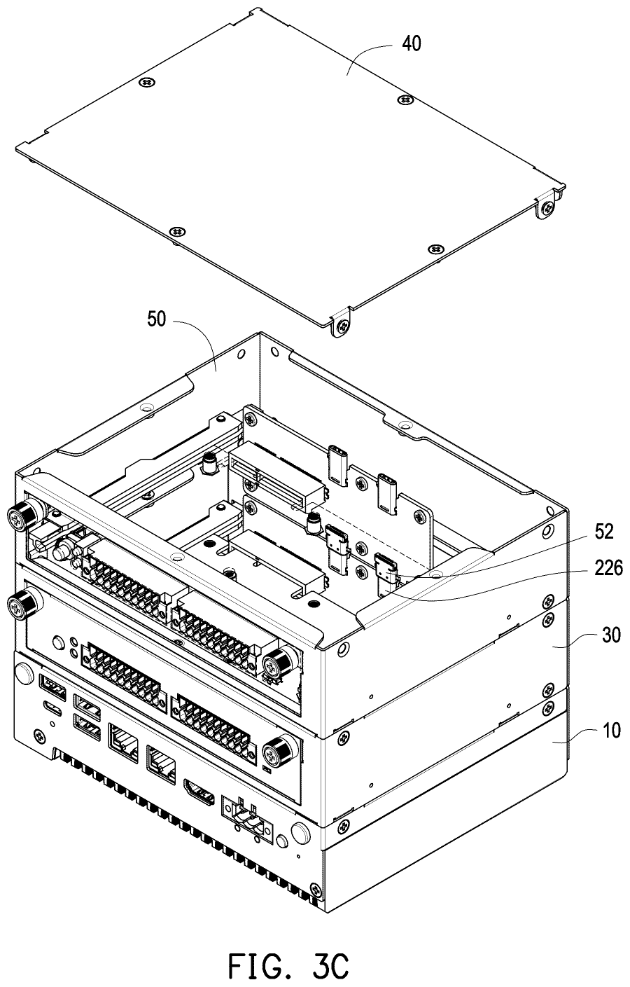

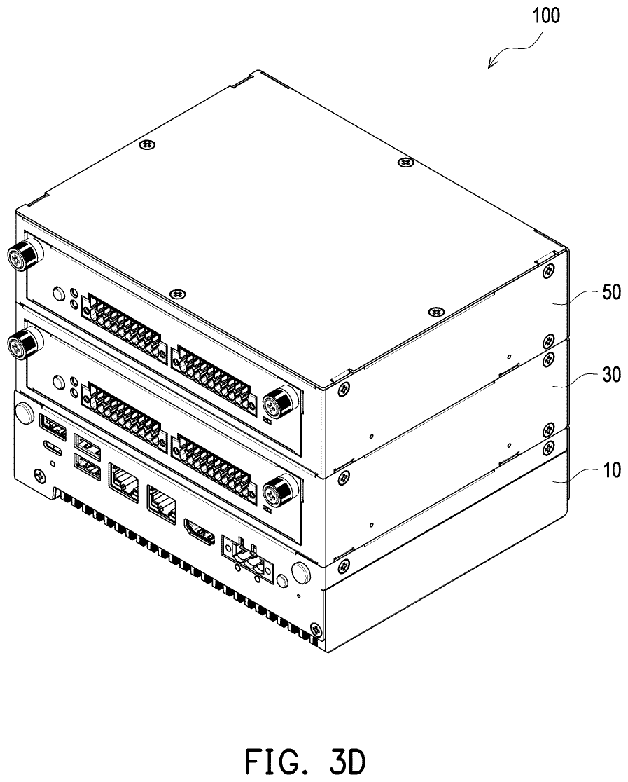

FIG. 3A to FIG. 3D are schematics of showing the second function expansion module being assembled onto the first function expansion module.

As shown in FIG. 3A, the top cover 40 assembled on the first function expansion module 30 is removed, exposing the fifth connector 226 disposed on the first adapter circuit board 220.

As shown in FIG. 3B, the second function expansion module 50 is assembled onto the first function expansion module 30, and the sixth connector 52 (shown in FIG. 3C) of the second function expansion module 50 is correspondingly connected with the fifth connector 226 disposed on the first adapter circuit board 220. In this way, the electrical connection between the second function expansion module 50 and the motherboard 130 to transmit signals is accomplished.

Then, as shown in FIG. 3C, the top cover 40 is assembled onto the top of the second function expansion module 50 to cover the interior of the second function expansion module 50, as shown in FIG. 3D.

Considering the overall lightweight demand for the electronic device assembly 100, in one embodiment, the adapter circuit boards of the second and subsequent function expansion modules are directly fastened to the corresponding frame, only one base 210 set is provided for support function at the host 10.

In another embodiment not illustrated, each function expansion module stacked on the host 10 is provided with a base 210, and these bases 210 of the function expansion modules are stacked one after another to provide support function. Although this method makes the overall weight of the electronic device assembly 100 heavier, the connection stability between the circuit adapter board and the function expansion board 330 is enhanced by the mutually stacked bases 210.

Incidentally, please refer to FIG. 2 and FIG. 3B together, the second function expansion module 50 of this embodiment is actually similar to the first function expansion module 30, with the difference being: the second frame 510 of the second function expansion module 50 is different from the first frame 310 of the first function expansion module 30. Specifically, the first frame 310 of the first function expansion module 30 is, in fact, U-shaped, while the second frame 510 of the second function expansion module 50 is rectangle-shaped.

The structure, configuration and assembly method of the function expansion board 330 of the second function expansion module 50 are actually the same as those of the function expansion board 330 330 of the first function expansion module 30, therefore they will not be repeated.

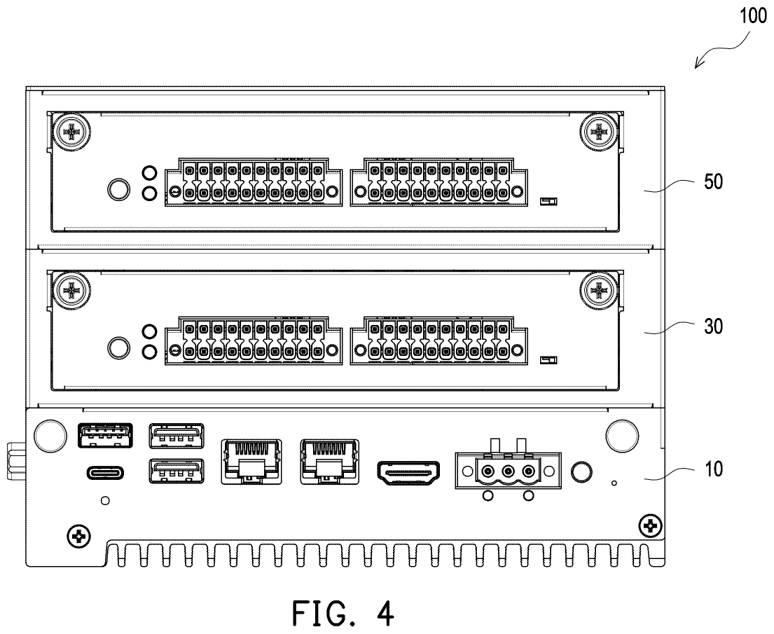

FIG. 4 is a schematic of showing the first function expansion module identical to the second function expansion module. Referring to FIG. 4, in this embodiment, the second function expansion module 50 has function expansion components identical to those of the first function expansion module 30. Specifically, the first function expansion module 30 and the second function expansion module 50 have the same input/output (Input/Output; I/O) interface. However, in another embodiment not illustrated, the second function expansion module 50 may have function expansion components different from those of the first function expansion module 30.

In addition, although this embodiment only illustrates two function expansion modules 30 as an example, in practical applications, multiple function expansion modules 30 may be stacked on the host 10 for use according to practical requirements.

In summary, in the electronic device assembly of this disclosure, by stacking function expansion modules in the height direction of the host, the expanding functionality can be achieved without changing the dimension of the motherboard of the host. As a result, the electronic device may be provided with function expansion modules with corresponding functions according to the different industrial requirements, and the quantity of function expansion modules may be determined according to requirements, thereby greatly enhancing the industrial adaptability of the electronic device assembly.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. An electronic device assembly, comprising:
a host, comprising a first housing and a motherboard disposed in the first housing;
a second housing, assembled on a side of the first housing, the second housing having a base;
a first adapter circuit board, disposed on the base, and a normal direction of the first adapter circuit board is perpendicular to a normal direction of the motherboard, and the first adapter circuit board is electrically connected to the motherboard; and
a first function expansion module, disposed on the host, wherein the first function expansion module is electrically connected to the first adapter circuit board, the first function expansion module contains a first frame and a function expansion board, the first frame has a pair of first sub-brackets facing each other, the pair of first sub-brackets have slide rails facing each other, the function expansion board has a sliding board, and the sliding board moves along the slide rails.

2. The electronic device assembly according to claim 1, wherein the motherboard is provided with a first connector, and the first adapter circuit board is provided with a second connector, the first connector and the second connector mate.

3. The electronic device assembly according to claim 1, wherein the first adapter circuit board is provided with a third connector, the first function expansion module has a fourth connector, and the third connector and the fourth connector mate.

4. The electronic device assembly according to claim 3, wherein the third connector is a slot, and the fourth connector is gold fingers.

5. The electronic device assembly according to claim 3, wherein the first function expansion module further comprising a function expansion circuit board, parallelly disposed on the sliding board, the function expansion circuit board has the fourth connector, the first frame further has a second sub-bracket connected between the pair of first sub-brackets, the second sub-bracket has a opening, the function expansion board further has a panel, the panel is disposed perpendicularly to the sliding board, and is adapted to cover the opening.

6. The electronic device assembly according to claim 5, wherein the first frame is U-shaped.

7. The electronic device assembly according to claim 1, further comprising a second function expansion module, the first function expansion module is located between the second function expansion module and the host, wherein the second function expansion module is electrically connected to the host.

8. The electronic device assembly according to claim 7, wherein the second function expansion module includes a second frame, and the second frame is rectangle-shaped.

9. The electronic device assembly according to claim 7, wherein the second function expansion module has a function expansion component the same as a function expansion component of the first function expansion module.

10. The electronic device assembly according to claim 1, further comprising a top cover.
